(19) United States
(12) Patent Application Publication
(10) Pub. No.: US 2008/0085176 A1
(43) Pub. Date: Apr. 10, 2008

(54) Vehicle accessory hoist

(76) Inventor: Sean C. Statkus, Jamul, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/542,803

(22) Filed: Oct. 4, 2006

(51) Int. Cl. B60P 9/00

(52) U.S. Cl. 414/462

(57) ABSTRACT

This invention relates to the field of devices used at the rear of a vehicle to carry accessories, such as bicycles, motorcycles, wheelchairs, electric carts, lawn care and construction equipment and a wide variety of other items that will not fit within the confines of the vehicle. It is directed to a vehicle accessory hoist providing a high strength, multipurpose compact device that will raise or lower an accessory carrier inserted into one or more universal hoist receivers to an elevated position keeping the centerline of the receivers horizontal at all times and can be easily removed from one vehicle and installed on another. The vehicle accessory hoist has a pair of primary support arms along with a pair of secondary support arms that are parallel mounted on a device frame and inclined equally, or otherwise, to their apex where they attach to a hoist receiver unit and are actuated by one or more actuating mechanisms. The hoist receiver is the same configuration as the conventional trailer hitch receiver used on vehicles allowing it to be used for a variety of existing accessory carriers which are readily available in worldwide commercial markets.

### FIELD OF THE INVENTION

This invention relates to the field of devices used at the rear of a vehicle to carry accessories, such as bicycles, motorcycles, wheelchairs, electric carts, generators, lawn care and construction equipment and a wide variety of other items that will not fit within the confines of the vehicle. More specifically this patent deals with a device that will lift by the means of one or more hydraulic units, linear actuators, pneumatic cylinders, hand cranks, winches or any other conventional extending or retracting mechanism raising the accessories in this fashion from ground level to an elevated position. By raising the accessories above the rear crash zone of the vehicle the tail lights and license plate are clearly visible from the rear increasing the safety and protecting them from unforeseen damage. Varieties of mounting means are foreseen, such as using an existing trailer hitch receptacle or mounting to the existing bumper, or directly to the vehicle frame.

### BACKGROUND OF THE INVENTION

This inventor having a great deal of experience with heavy equipment and construction has found a need for safely transporting large items that will not fit into his construction truck or within his travel trailer when he and his family are vacationing. His desire has been to devise a device that could raise a heavy load into an elevated position along with being easily removed from one vehicle and transferred to another. Of major importance was that the device would be compact, have heavy-duty construction with diagonal bracing to minimize rocking of the load when it was elevated and be available with a wide variety of actuating means. Additionally, a system has been devised to strengthen the union between the trailer hitch receiver on the vehicle and the mounting tongue of the vehicle accessory hoist.

A major problem with most devices at the rear of vehicles that hold items like wheelchairs and electric carts is that they obscure the license plate and the tail lights to some degree. The problem has been such that the state of California has adopted a vinyl license plate to be installed in the rear window of vehicles with handicapped passengers requiring wheelchairs or electric carts because the license plate was obscured by the rear wheelchair hoist. The device will have an accessory hoist receiver similar to the conventional trailer hitch receiver as a means of coupling to different commercially available devices such as wheelchair, bicycle and motorcycle racks, ski racks, cargo racks, and custom built racks that normally attach to the trailer hitch socket on vehicles. All pivot points will be equipped with quality polyurethane bushings or equivalent, such as PTFE, steel pins, bolts, brass or titanium. The device will be securely padlocked or pinned when the load is in the upper stowed position. An additional capability of the unique device will be raising a load on a platform from ground level to an elevated position where the load could be easily transferred into the vehicle rear storage area.

U.S. Pat. No. 5,456,564 of Thomas R. Bianchini describes a winch operated vehicle mounted carrier comprised of an upper rectangular section having a securement bar extending inwardly therefrom. The securement bar is received within a class 3 trailer hitch for securement of the upper rectangular section thereto. An electric winch is secured to the upper rectangular section. The electric winch has a drive cable there secured. The drive cable has a securement portion extending downwardly therefrom. The invention includes two pairs of arms. Each of the two pairs of arms is pivotally secured to a lower portion of the upper rectangular section. A lower support bracket is pivotally secured to an opposing end of the two pairs of arms. A latch is secured to a middle portion of the lower support bracket. The latch couples with the securement portion of the drive cable of the electric winch. A lower support tray is secured across the lower support bracket. Two spring-loaded catches are secured to an outer portion of the upper rectangular section. The catches engage the outwardly extending tabs of the arms in a locked position when the electric winch pulls the lower support bracket to a position adjacent the upper rectangular section.

This patent describes a winch operated vehicle mounted carrier that has not been designed to operate by any other means than the winch system. There is no diagonal bracing to minimize the swaying motion when the weight is extended into the upright position, no reinforcing at the mounting position and it has specifically been designed as a single purpose system. It is large and cumbersome adding more weight to the rear of the vehicle than necessary and cannot easily be removed from the vehicle, and it requires specially built accessories that will only function properly with that specific unit.

U.S. Pat. No. 6,364,597 of Eric E. Klinkenberg describes a hydraulic lift that is provided for carrying structures, such as a motorcycle, snowmobile, etc., in an elevated position behind a motor home. The lift includes a fixed framework having pivotal arms to which any of a plurality of carrying platforms may be engaged. The arms pivot from a ground engaging position to an elevated, locked in place position under action of a hydraulic activation system.

This patent describes a hydraulic lift that has been designed to be permanently mounted to the frame of the vehicle. The device could not be easily removed from one vehicle and moved to another. It has been designed to use hydraulics but would probably work equally with linear actuators although it has not been designed to use any form of winch system. Varieties of lifting platforms are stated within the patent, but they require special mounting equipment that is unique to this device only. Parallel lifting arms using hydraulics is a common practice used in heavy equipment like the Bobcat and Skidsteers that have been on the market for many years.

It has been found through the endeavors of the inventor and the patent search that there is no apparatus on the market and no apparent patents reviewed that have similar characteristics to the unique vehicle accessory hoist described within this patent.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### SUMMARY OF THE INVENTION

The principal advantage of this invention is to create a compact, heavy duty vehicle accessory hoist that can be easily removed from one vehicle and moved to another.

Another advantage of the vehicle accessory hoist is to create a device that can accommodate existing carriers that are on the market like those for wheelchairs, bicycles and motorcycles, etc. all readily available commercially and sold worldwide.

Another advantage of the vehicle accessory hoist is to create a device capable of being mounted directly to the vehicle frame and/or vehicle bumper assembly.

Another advantage of the vehicle accessory hoist is to create a device which is scalable, having uses ranging from light to extremely heavy duty applications.

Another advantage of the vehicle accessory hoist is to create a device that can be adapted to operate by one or more means being: hydraulics, linear actuators, pneumatic cylinders, manual screw jacks, a winch system, or air bags.

Another advantage of the vehicle accessory hoist is by making minor modifications different lengths of actuating mechanisms may be incorporated into the design, contributing both to the physical scalability of the unit as well as the scalability in manufacturing different sized units, thereby benefiting the consumer as well as the manufacturer.

Another advantage of the vehicle accessory hoist is to create a device where the load receiver rests on a central support member attached to the two primary support arms, removing the load from the hydraulic cylinder or other actuating device and may be locked into this position.

Another advantage of the vehicle accessory hoist is to create a device that can be adapted to mount over an extended trailer hitch tongue and ball on a vehicle towing a trailer.

And still another advantage is to create a system that will strengthen the union of the receiver on the vehicle and the mounting tongue on the vehicle accessory hoist and eliminate the limited movements within the vehicle receivers.

Another advantage of the device is to be able to add multiple accessory receivers and strength members to the hoist receiver unit.

Another advantage of the device is to be able to incorporate limiting stops in the elevated position to maintain the distance from the vehicle, or to compensate for load clearance or the profile configuration of the carrier vehicle.

Another advantage of the device is to incorporate a spare tire mount on the vehicle accessory hoist, or any number of other secondary accessories otherwise to be normally mounted to a vehicle, such as jacks, etc.

A further advantage of the vehicle accessory hoist is to create a device that will raise the accessory being transported above the rear end crash zone and have the tail lights and license plate clearly visible form the rear.

And yet another advantage of this invention is to add a new and unique multipurpose device to the area of after market vehicle products with utility uses as well as recreational uses.

These together with other advantages of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The preferred embodiment of this invention will consist of vehicle accessory hoist incorporating one or more optional actuating mechanisms which may be a hydraulic cylinder, a pneumatic cylinder, air bag, manual screw jacks or work as a linear actuator. Linear actuators are electrically driven ball screws that provide high performance and accurate positioning. An additional alternate embodiment of the vehicle accessory hoist will incorporate a winch to perform the desired operation. All of the actuating mechanisms will perform similar operations and will fall within the scope of this patent. The power supply for the actuating mechanism can be mounted to the hoist frame or can be remotely housed within the vehicle.

A unique system that will strengthen the union of the receiver on the vehicle and the mounting tongue on the vehicle accessory hoist was created for this device. A square channel support is welded to the square channel frame member over the hoist mounting tongue with one or more binding bolts. The trailer hitch receiver slides within the gap between the hoist mounting tongue and the square channel support after which the locking pin is inserted through the locking pin orifice. The binding bolts then can be tightened down to strengthen the union of the trailer hitch receiver and the hoist mounting tongue eliminating movement within the trailer hitch receiver.

The function accomplished by this patent is providing a high strength, compact device that will raise or lower an accessory carrier inserted into a universal hoist receiver to an elevated position and can be easily removed from one vehicle and installed on another. The vehicle accessory hoist has a pair of primary support arms along with a pair of secondary support arms that are parallel and mounted on a device frame that are inclined to or near their apex where they attach to a hoist receiver unit. The hoist receiver is the same configuration as the conventional trailer hitch receiver used on vehicles allowing it to be used for a variety of existing accessory carriers.

The preferred embodiment of the invention will have a central support member connecting the first and second primary support arms that will form a rest for the hoist receiver, removing the load from the actuating mechanism when hoist is in the fully raised position. Additionally, a spring loaded locking mechanism will hold the device in the upper most position by the means of a handle operating a cross over rod with two locking arms that will engage over two locking stops. A padlock can then be used to lock the device safely in the up position.

The first alternate embodiment of the vehicle accessory hoist will incorporate a single smaller actuating mechanism attached to two cross bars located between the two primary support arms and the two secondary support arms. Two pivot joints are attached to a link arm making a rotating linkage between the two cross bars. A clevis is attached to the actuating mechanism connecting to the link arm.

The second alternate embodiment will incorporate a winch frame attached to the frame member to accommodate the cable winch assembly. A third alternate embodiment of the vehicle accessory hoist is in a permanently lowered position using an airbag cushion, spring over hydraulic cylinder or shock absorber as a stabilizer between the hoist tongue when placed in the vehicle receiver and the hoist receiver unit when an accessory or conventional trailer hitch and ball is added.

Multiple accessory receivers and strength members can be added to the hoist receiver unit to enhance the structural strength and capabilities of the vehicle accessory hoist.

Limiting stops can be incorporated between the primary support arms and the secondary support arms to maintain the distance from the vehicle when the device is in the elevated position.

A spare tire mount may be permanently attached or be removable from the secondary support arms on the vehicle accessory hoist.

An angled frame member instead of the square or channel frame member, with multiple clamping brackets having a support web on the back side will clamp over an existing square bumper.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the detailed description, serve to explain the principles of this invention.

FIG. 1 depicts a perspective view of the preferred embodiment of the vehicle accessory hoist incorporating an actuating mechanism which may be a hydraulic cylinder, a pneumatic cylinder or work as a linear actuator.

FIG. 2 depicts a rear simplified view of the preferred embodiment of the vehicle accessory hoist exhibiting an actuating mechanism which may be a hydraulic cylinder, a pneumatic cylinder or a linear actuator with section arrows for FIG. 5.

FIG. 3 depicts a sectional view of the preferred embodiment of the vehicle accessory hoist in a raised position.

FIG. 4 depicts a sectional view in detail of the preferred embodiment of the vehicle accessory hoist in a raised position illustrating the hoist receiver resting on the primary support arms.

FIG. 5 depicts a sectional view of the preferred embodiment of the vehicle accessory hoist in a partially lowered position illustrating the various inscribed arcs of the upper pivot points.

FIG. 6 depicts a sectional view of the preferred embodiment of the vehicle accessory hoist in a lowered position.

FIG. 7 depicts a perspective view of the unique configuration of the central support member attached to the two primary support arms.

FIG. 8 depicts a perspective view of the first alternate embodiment of the vehicle accessory hoist in a lowered position with a single smaller actuating mechanism attached to two cross bars.

FIG. 9 depicts a perspective view of the first alternate embodiment of the vehicle accessory hoist in a raised position.

FIG. 10 depicts a perspective view of the second alternate embodiment of the vehicle accessory hoist incorporating a winch and a square channel frame member to go over an existing vehicle bumper.

FIG. 11 depicts a perspective view of the second alternate embodiment of the vehicle accessory hoist incorporating a winch with a square tubular frame member and an extended trailer hitch tongue with ball.

FIG. 12 depicts a rear view of the preferred embodiment of the vehicle accessory hoist mounted on a trailer or motor home type of vehicle depicting the rear crash zone and the accessory being a bicycle rack raised above the tail lights and license plate.

FIG. 13 depicts a side view of the preferred embodiment of the vehicle accessory hoist mounted on a trailer or motor home type of vehicle.

FIG. 14 depicts a perspective view of the vehicle trailer hitch receiver, the accessory hoist mounting tongue and the reinforcing means welded to the channel frame member.

FIG. 15 depicts a side sectional view of the third alternate embodiment of the vehicle accessory hoist in a permanently lowered position using an airbag cushion as a stabilizer between the hoist tongue when placed in the vehicle receiver and the hoist receiver.

FIG. 16 depicts a simplified side view of the vehicle accessory hoist in an up position and the inscribed arcs made by the upper pivot points indicating that the centerline of the receiver remains parallel with the surface of the ground.

FIG. 17 depicts a simplified side view of the vehicle accessory hoist in a lowered position and the inscribed arcs made by the upper pivot points.

FIG. 18 depicts a simplified side view of the vehicle accessory hoist in an up position with a pivoting angle platform.

FIG. 19 depicts a simplified side view of the vehicle accessory hoist in a partially lowered position with a pivoting angle platform resting on the ground.

FIG. 20 depicts a side view of the square tubular frame member with a single reinforced bracket system for the primary and secondary support arms.

FIG. 21 depicts a perspective view of the square tubular frame member with a single reinforced bracket system for the primary and secondary support arms.

FIG. 22 depicts a side view of an optional round tubular frame member with a single reinforced bracket system for the primary and secondary support arms.

FIG. 23 depicts a detail view of the hoist receiver unit of the vehicle accessory hoist with the capability of adjusting the length of the primary support arms to adjust the angle on the accessory hoist receiver.

FIG. 24 depicts an exploded perspective view of the preferred embodiment of the vehicle accessory hoist with options of the two additional secondary receiver units or the two strength members with the addition of an optional spare tire mount.

FIG. 25 depicts a perspective view of the secondary receiver unit with the optional round mating boss.

FIG. 26 depicts a rear view of the preferred embodiment of the vehicle hoist with two actuating mechanisms and the additional secondary receiver units.

FIG. 27 depicts a perspective view of the limiting stop that can be incorporated between the primary support arms and the secondary support arms to maintain the distance from the vehicle when the device is in an elevated position.

FIG. 28 depicts a detail in perspective of one end of an angled frame member with multiple clamping brackets having a support web on the backside.

FIG. 29 depicts a front view of a slight modification of the preferred embodiment of the vehicle accessory hoist where the primary support arms and the secondary support arms are at different angles.

FIG. 30 depicts a front view of a slightly modified first alternate embodiment using two additional support arms and a short actuating mechanism.

FIG. 31 depicts a perspective detail of an optional locking system in the upright position while holding the trailer hitch tongue in the tubular hoist receiver.

### DETAILED DESCRIPTION OF THE PREFERRED EMBODIMENTS

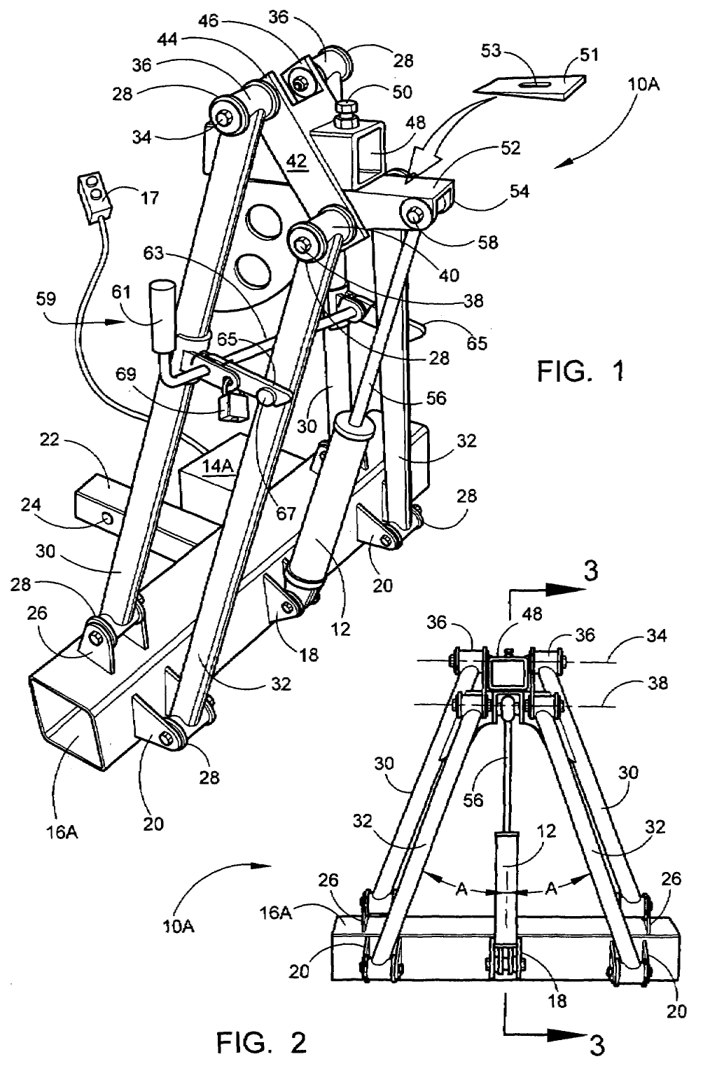

Referring now to the drawings, wherein similar parts of the vehicle accessory hoist 10A are identified by like reference numerals, there is seen in FIG. 1 a perspective view of the preferred embodiment of the vehicle accessory hoist 10A incorporating an actuating mechanism 12 which may be a hydraulic cylinder, a pneumatic cylinder or work as a linear actuator and still fall within the scope of this patent. The power supply 14A for the actuating mechanism 12 is shown adjacent to the square tubular frame member 16A controlled by a remote mechanism 17 but it may be also housed within the vehicle. The actuating mechanism mounting bracket 18 is shown centrally located on the square tubular frame member 16A but it must be made clear at this time that one or more actuating mechanisms and mounting brackets may be used to accomplish the task and the tubular frame member 16A can be square, channel shaped, angle iron or round and will additionally be covered within the scope of this patent. At the distal ends of the square tubular frame 16A and on the same side as the actuator mounting bracket 18 are the secondary support arm mounting brackets 20.

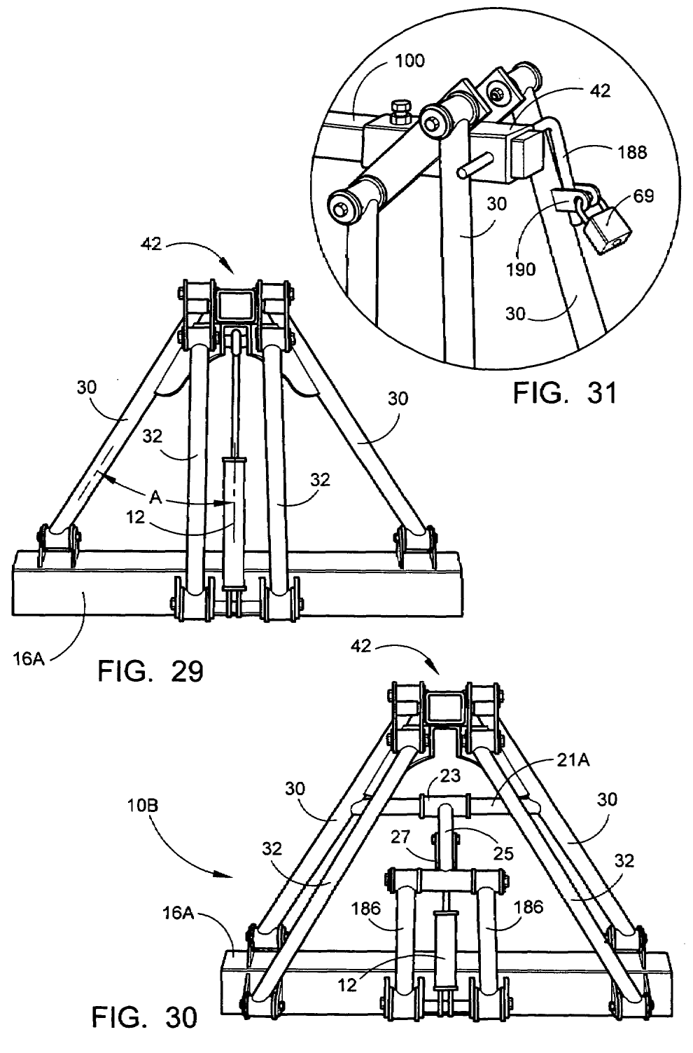

Centrally located on the opposite side of the square tubular frame 16A from the actuating mechanism mounting bracket 18 is the vehicle accessory hoist mounting tongue 22 with the locking pin orifice 24. At the top of the square tubular frame member 16A on the distal ends are the primary support arm brackets 26. All the pivot points on the vehicle accessory hoist 10A will be equipped with high density, graphite impregnated polyurethane bushings 28 or equivalent, such as PTFE, steel pins, bolts, brass or titanium. Two primary support arms 30 are attached to the two primary support arm brackets 26 and are inwardly inclined at angle A. The angle A of inclination of the primary support arms 30 and the secondary support arms 32 may be the same, but need not be as illustrated in FIG. 29, and the combined angle A may be altered during the manufacturing process by the weight and functional requirements of the device.

The primary support arms 30 are connected at their apex by common centerline 34 through the pivotal connections 36 housed within bushings 28. Two secondary support arms 32 are attached to the two secondary support arm brackets 20 and may be similarly inwardly inclined. The secondary support arms 32 are connected at their apex by common centerline 38 through pivotal connections 40 housed within bushings 28. The primary support arm pivotal connections 36 and the secondary support arm pivotal connection 40 are substantially connected by the means of the hoist receiver unit 42. The hoist receiver unit 42 is comprised of two side plates 44 and 46 that are welded to a square tubular hoist receiver 48. The hoist receiver will incorporate the conventional locking pin with an additional retainer binding bolt 50.

The square tubular hoist receiver 48 rests on the flat upper surface 52 of the central support member 54 that is connected to the two primary support arms 30 when the device is in the upright position thereby substantially removing the load weight from the actuating mechanism 12. A wedge piece 53 can be placed upon the upper flat surface 52 of the central support member (see arrow). This wedge piece 53 can be slid forward and backward along an oval shaped wedge piece orifice 53 and locked into place over the slot in the support member 66 (not shown here see FIG. 7). In this way, the hoist receiver 48 stops and rests in a level position upon the central support member 54.

The pressure rod 56 of the actuating mechanism 12 is connected to the central support member 54 at the pivotal connection 58. A remote control mechanism 17 allows the user to stand clear, keeping arms and legs away from the actuating lift, for safe operation. A spring loaded locking mechanism 59 to hold the device in the upper most position will consist of a handle 61 operating a cross over rod 63 with two locking arms 65 that will engage over two locking stops 67. A padlock 69 can then be used to lock the device safely in the up position.

FIG. 2 depicts a rear simplified view of the preferred embodiment of the vehicle accessory hoist 10A exhibiting the actuating mechanism 12 which may be a hydraulic cylinder, a pneumatic cylinder or a linear actuator. The spring loaded locking mechanism has been omitted for clarity. The vehicle accessory hoist 10A is shown symmetrical about the centerline where section 3-3 is taken clearly indicating the possible inclining angle A of either side.

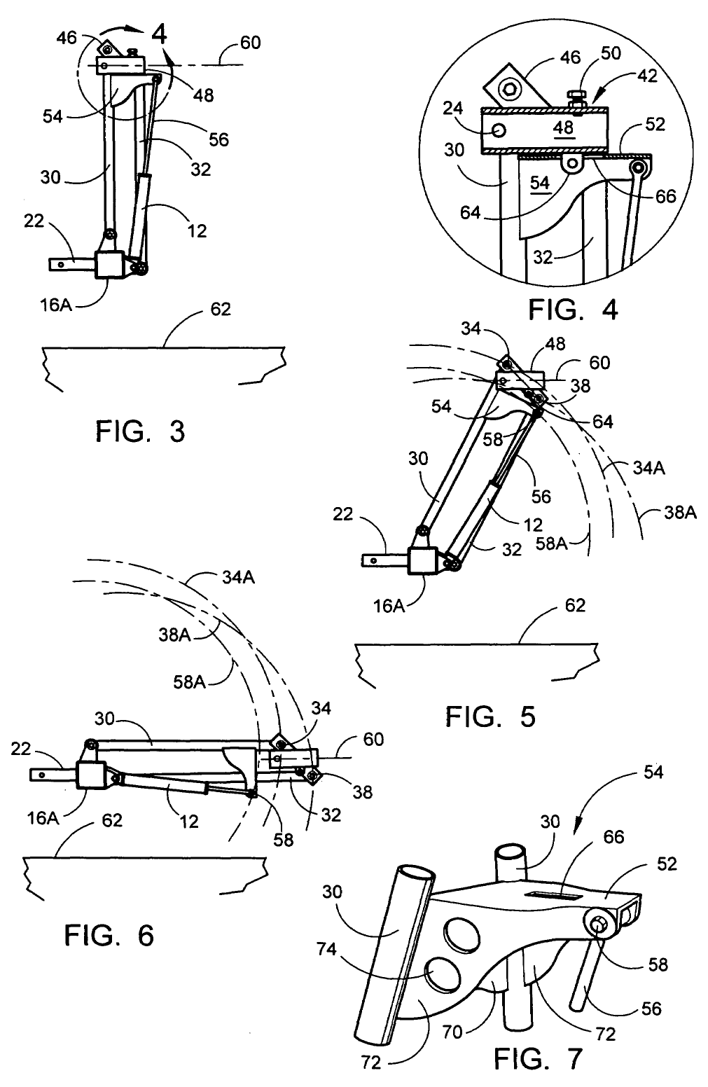

FIG. 3 depicts a simplified sectional view of the preferred embodiment of the vehicle accessory hoist 10A in an up position where the primary and secondary actuating arms 30 and 32 are vertical and the actuating mechanism 12 is extended. The centerline 60 of the tubular hoist receiver 48 remains parallel with the ground surface 62 during the complete lifting operation, unless an adjustment in the length of primary or secondary arms is made as illustrated in FIG. 23.

FIG. 4 also depicts a sectional view in detail of the preferred embodiment of the vehicle accessory hoist 10A in an up position further illustrating the hoist receiver 48 resting on the central support member 54 with the locking tab 64 protruding through slot 66 on the central support member flat upper surface 52 using a conventional pad lock to lock the device in the up position. A locking pin orifice 24 will be in the tubular hoist receiver 48 to lock in the tongue of a variety of existing carriers that are on the market like those for wheelchairs, bicycles and motorcycles, scooters, personal vehicles, ski racks, etc. One or more additional binding bolts 50 will be added to tightened down and strengthen the union of the hoist receiver 48 and the mounting tongue on the accessory eliminating movement within the receiver.

FIG. 5 depicts a simplified sectional view of the preferred embodiment of the vehicle accessory hoist 10A in partially lowered position illustrating the inscribed arc 34A of the primary support centerline 34, the arc 38A of the secondary support arm centerline 38 and the pivotal connection arc 58A made by the pivotal connection 58 and the fact that the hoist receiver centerline 60 remains parallel to the ground surface 62 during the complete lowering process. The locking tab 64 translates out of the slot 66 in the central support member 54.

FIG. 6 depicts a simplified sectional view of the preferred embodiment of the vehicle accessory hoist 10A with the actuating mechanism in a lowered position further illustrating the inscribed arcs of the primary support centerline 34, the secondary support arm centerline 38 and the pivotal connection 58 and the fact that the hoist receiver centerline 60 still remains parallel to the ground surface 62. The vehicle accessory hoist 10A can also be lowered to the point of resting on the ground or very near to the ground level.

FIG. 7 depicts a perspective view of the unique configuration of the central support member 54 attached to the two primary support arms 30. The central support member 54 is comprised of a flat upper surface 52 with a locking slot 66, a rear plate 70 extending between the primary support arms 30 and two contoured side plates 72. The rear plate 70 and the side plates 72 may have one or more orifices 74 for reducing the overall weight of the device.

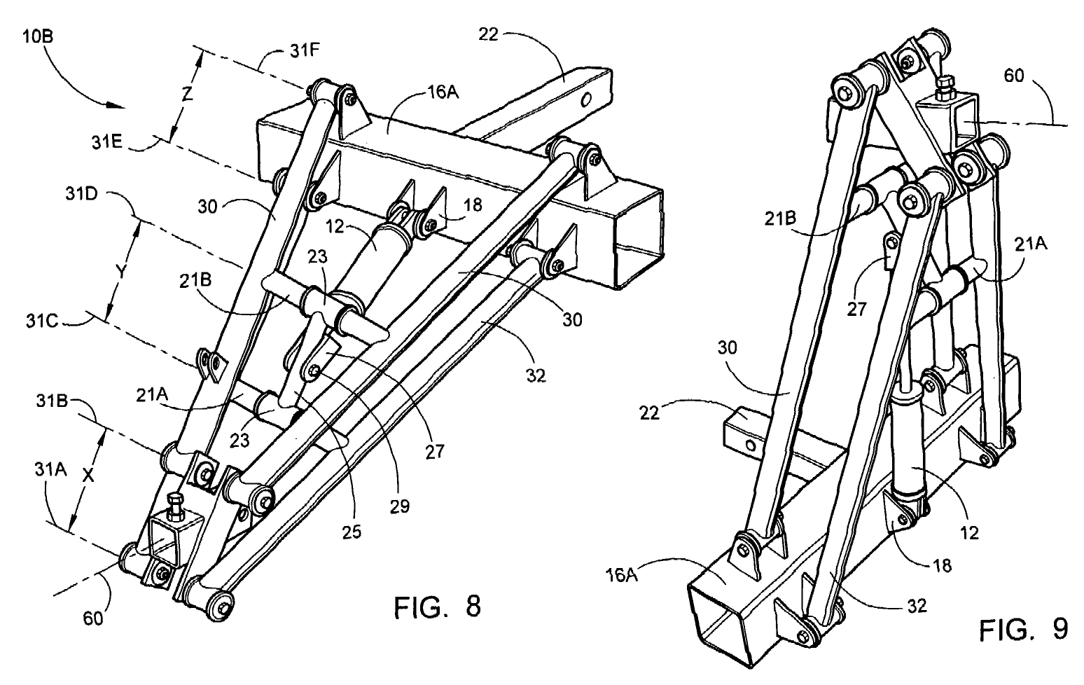

FIG. 8 depicts a perspective view of the first alternate embodiment of the vehicle accessory hoist 10B in the lowered position with a single smaller actuating mechanism 12 attached to two cross bars 21A and 21B located between the two primary support arms 30 and the two secondary support arms 32. Two pivot joints 23 are attached to a link arm 25 making a rotating linkage between the two cross bars 21A and 21B. A clevis 27 attached to the actuating mechanism 12 connects to the link arm 25 by the means of an attachment pin 29. This illustration clarifies the equal distant pivot point centerline spacing X, Y and Z of center lines 31A, 31B, 31C, 31D, 31E and 31F. Further emphasizing the precise positioning required for this operation.

FIG. 9 depicts a perspective view of the first alternate embodiment of the vehicle accessory hoist 10B in a raised position.

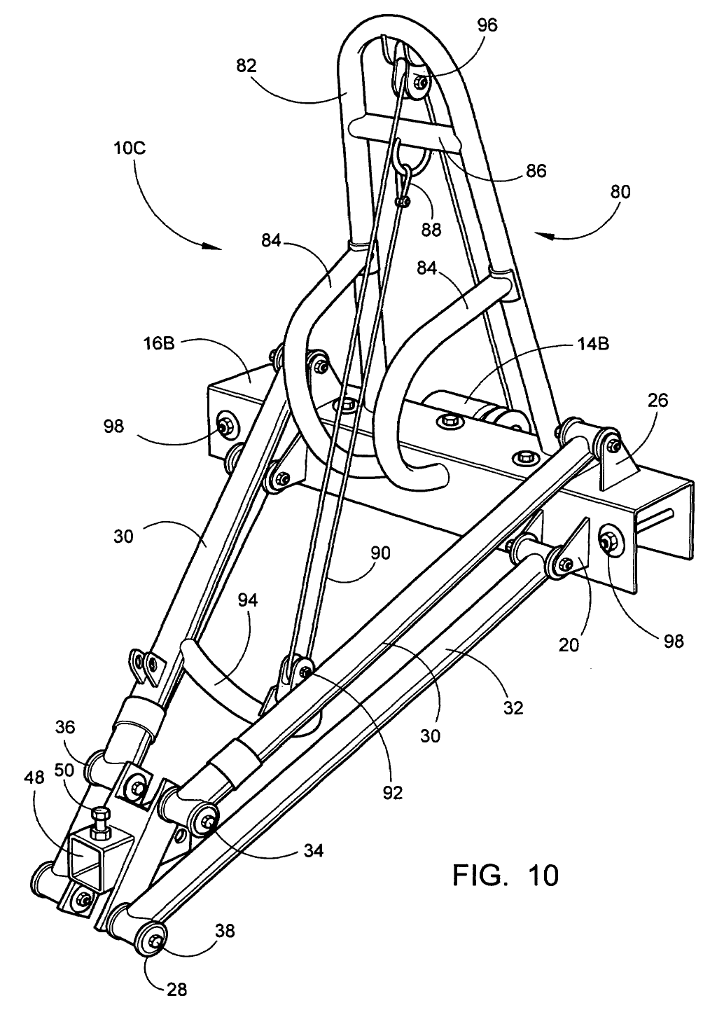

Referring now to FIG. 10 depicting a perspective view of the second alternate embodiment of the vehicle accessory hoist 10C incorporating a winch mechanism 80 to actuate the device by the means of a actuator power mechanism 14B and an optional square channel frame member 16B to go over an existing vehicle bumper. The vehicle accessory hoist 10C is comprised of all the essential parts of the vehicle accessory hoist 10A with the addition of the winch support frame member 82 having two support braces 84. A cross bar 86 is the attachment means for the cable end 88 with the cable 90 extending to the first pulley 92 attached to a second cross bar 94 located between the two primary support arms 30. From the first pulley 92, the cable 88 continues to the second pulley 96 attached at the top of the winch support frame member 82 and down to the power actuating mechanism 14B. Several mounting bolts 98 will be used to attach the vehicle accessory hoist 10C to the existing bumper of the vehicle.

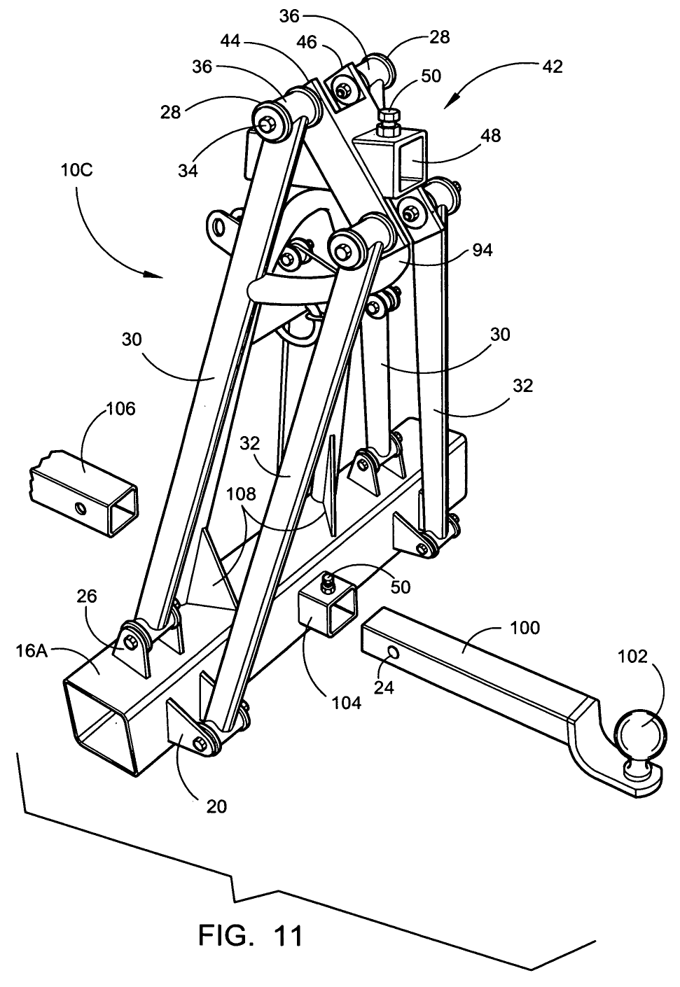

FIG. 11 depicts a perspective view of the second alternate embodiment of the vehicle accessory hoist 10C incorporating a winch with a square tubular frame 16A member and an extended trailer hitch tongue 100 with ball 102. A sleeve 104 is fixably welded in place through the square tubular frame 16A to allow the extended trailer hitch tongue 100 to protrude through the device into the trailer hitch receiver 106 of the vehicle. A binding bolt 50 will be added to tightened down and strengthen the union of the sleeve 104 and the extended trailer hitch tongue 100 eliminating movement within the sleeve 104. Angle gussets 108 are used to replace the support braces 84 illustrated in FIG. 8. The sleeve 104 can also be welded below the square tubular frame 16A still remaining within the scope of this patent. FIG. 11 also depicts secondary support arms 32 resting firmly against curved crossbar 94 helping to self-center the unit and create instant (when fully raised) additional lateral support in the raised position.

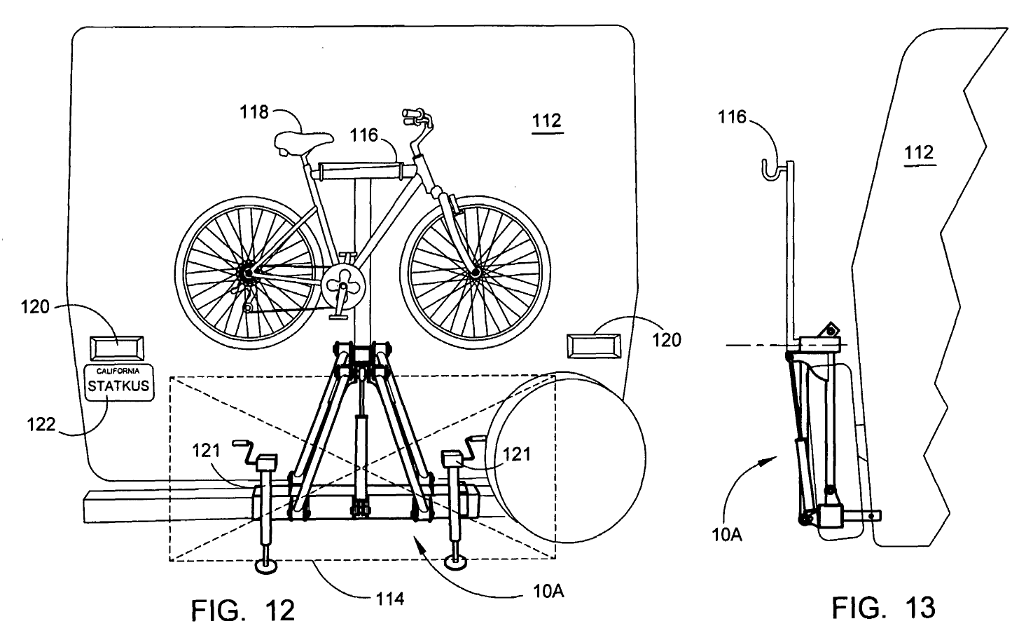

FIG. 12 depicts a rear view of the preferred embodiment of the vehicle accessory hoist 10A mounted on a trailer or motor home type of vehicle 112 depicting the rear crash zone 114 and the accessory being a bicycle rack 116 holding a bicycle 118 raised above the tail lights 120 and license plate 122 and above the spare tire rack making it centrally located to clear the roof ladder, license plate and vehicle lights on a trailer or RV so equipped. The unit is scalable to have a lifting capacity of thousands of pounds and some RV and other vehicle bumpers are not sturdy enough to support that kind of weight when lifting through the arc of hoisting said weight. Therefore, optionally, landing gear 121 can be fitted to the bumper, as shown here in FIG. 12. The landing gear 121 is adjustable to the height necessary, and allows transfer of the weight applied to the bumper of the vehicle to the ground.

FIG. 13 depicts a side view of the first alternate embodiment of the vehicle accessory hoist 10A mounted on a trailer or motor home type of vehicle 112.

FIG. 14 depicts a perspective view of the vehicle trailer hitch receiver 106, along with the accessory hoist mounting tongue 22 attached to the square channel frame member 16B. A square channel support 124 is welded to the square channel frame member 16B over the hoist mounting tongue 22 with one or more binding bolts 68. The trailer hitch receiver 106 slides within the gap 126 between the hoist mounting tongue 22 and the square channel support 124 after which the locking pin 128 is inserted through the locking pin orifice 24. The binding bolts 50 then can be tightened down to strengthen the union of the trailer hitch receiver 106 and the hoist mounting tongue 22 eliminating movement within the trailer hitch receiver 106. This system will also be incorporated on the square tubular frame member 16A.

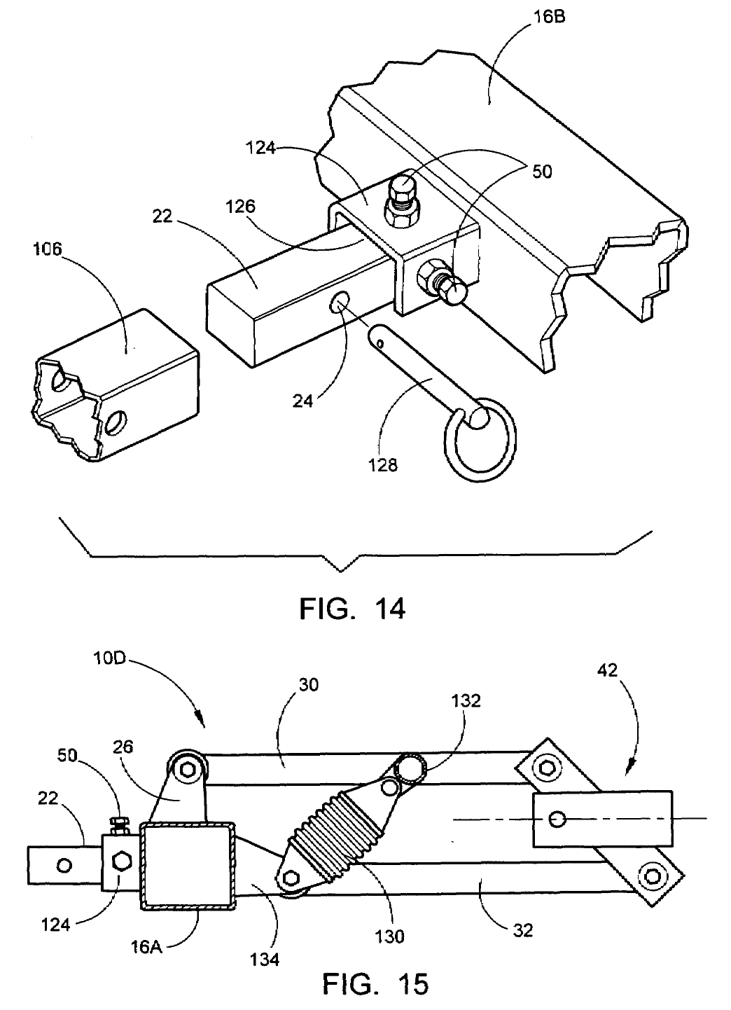

Referring now to FIG. 15 showing a side view of the third alternate embodiment of the vehicle accessory hoist 10D is in a permanently lowered position using an airbag cushion 130 or spring over hydraulic cylinder as a stabilizer between the hoist tongue 22 when placed in the vehicle receiver 106 and the hoist receiver unit 42 when an accessory or conventional trailer hitch and ball is added. The airbag cushion 130 is supported between a cross brace 132 extending between the two primary support arms 30 and an air bag cushion bracket 134 attached to the surface of the tubular frame member 16A. This configuration also allows a user to raise or lower the trailer tongue, thereby leveling the trailer load or creating a loading ramp.

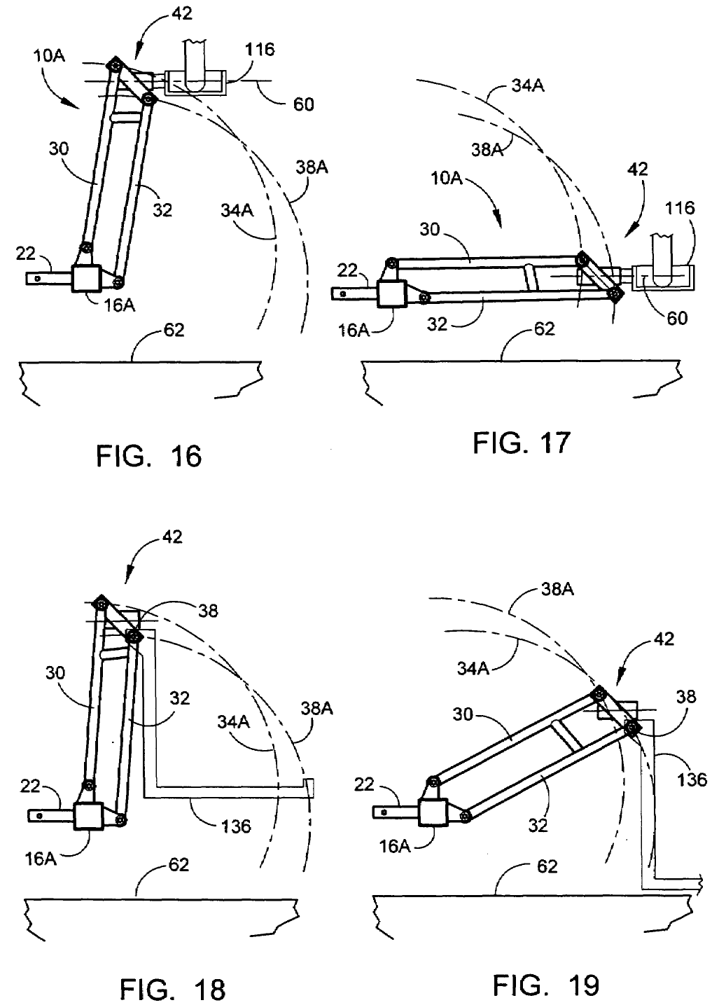

FIG. 16 depicts a simplified side view of the vehicle accessory hoist 10A in the up position and the inscribed arc 34A of the primary support centerline 34, and the arc 38A of the secondary support arm centerline 38 made by the upper pivot points 34 and 38 indicating that the centerline of the receiver and bicycle rack 116 remains parallel with the surface of the ground 62. FIG. 17 depicts a simplified side view of the vehicle accessory hoist 10A in a lowered position and the inscribed arcs made by the upper pivot points.

FIGS. 18 and 19 depict simplified side views of the vehicle accessory hoist 10A in the up position with a pivoting angle platform 136 attached along the secondary support arm centerline 38 allowing the angled support platform 136 to set flat no matter what the elevation of the ground 62, making it easier to load a wheelchair or scooter.

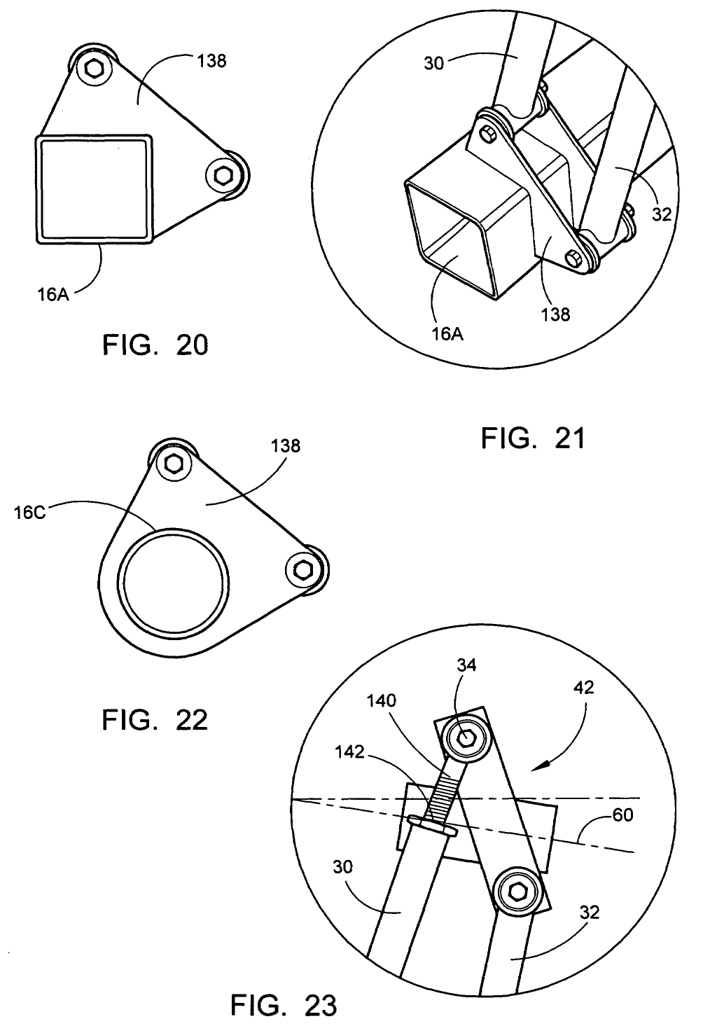

FIGS. 20 and 21 depict a side view and perspective view of the square tubular frame member 16A with an optional single reinforced bracket system 138 replacing the secondary support arm bracket 20 and the primary support arm bracket 26.

FIG. 22 depicts a side view of an optional round tubular frame member 16C with a single reinforced bracket system 138 for the primary and secondary support arms 30 and 32.

FIG. 23 depicts a detailed view of the hoist receiver unit 42 of the vehicle accessory hoist 10A with the capability of adjusting the length of the primary support arms 30 to adjust the angle on the accessory hoist receiver centerline 60. Threaded shaft 140 extends through threaded coupling 142 in the distal end of the primary support arms 30 allowing for the length adjustment changing the angle of the centerline 60 of the tubular hoist receiver 48.

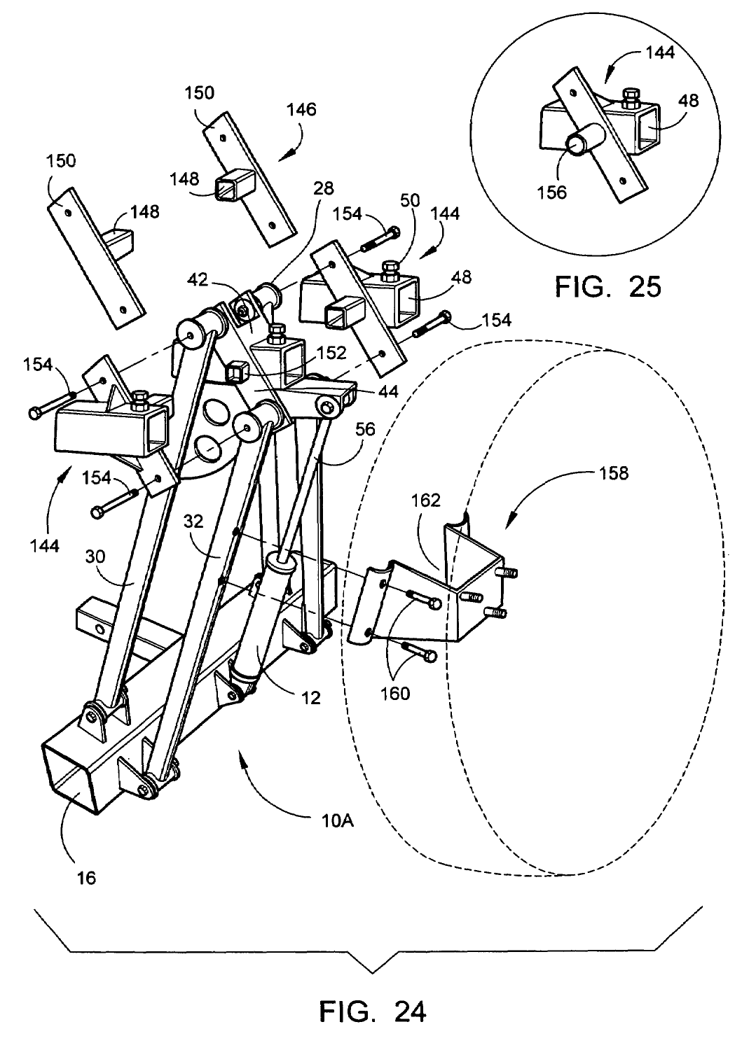

FIG. 24 depicts an exploded perspective view of the preferred embodiment of the vehicle accessory hoist 10A with option of the two additional secondary receiver units 144 or the two strength members 146. The secondary receivers add the capability of spreading out the weight of a heavier load over multiple attachment points, while the strength members reinforce the single receiver unit 42. Both the secondary receiver units 144 and the strength members 146 will incorporate square coupler 148 attached to the plate 150 and a square boss 152 welded on the side plate 44 of the receiver 42. With these units, a greater force can be exerted on the mounting bolts 154 without excessive squeeze on the bushings 28.

FIG. 25 depicts a perspective view of the secondary receiver unit 144 with the optional round mating boss 156 having a round coupler that is not shown. FIG. 24 additionally illustrates a spare tire mount 158 that can be permanently affixed to the two secondary support arms 32 or be removeably attached by the means of attachment bolts 160. The spare tire mount 158 is constructed with a cavity 162 allowing clearance for one or more actuator mechanisms 12 when the device is in the lowered position.

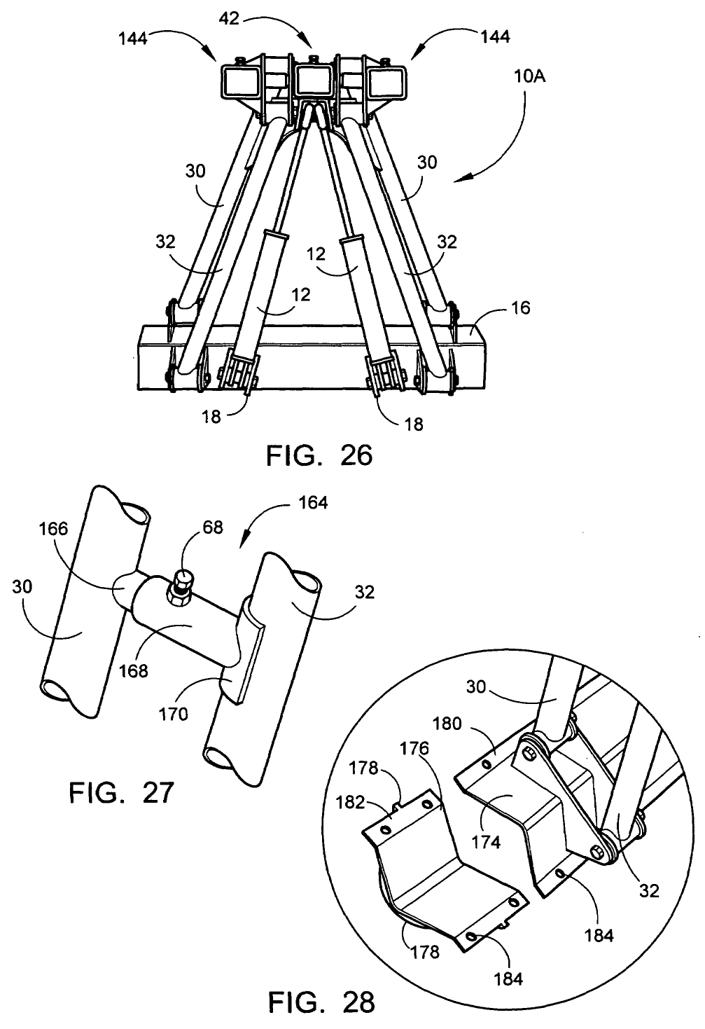

FIG. 26 depicts a rear view of the preferred embodiment of the vehicle hoist 10A with the optional two inclined actuating mechanisms 12. By inclining two actuating mechanisms 12 a greater load can be raised with the forces directed at he apex of the actuating mechanisms 12 and directly on the hoist receiver unit 42.

FIG. 27 depicts a perspective view of the limiting stop 164 that can be incorporated between the primary support arms 30 and the secondary support arms 32 to maintain the distance from the vehicle when the device is in the elevated position. The limiting stops 158 will consist of a tubular member 166 and stop coupler 168. The stop coupler will have a stop coupler binding bolt 68 to lock it into the desired elevated position and a shoe section 170 to rest against the secondary support arm 32 for the vehicle accessory hoist 10A.

FIG. 28 depicts a detail in perspective of one end of an angled frame member 174 with multiple clamping brackets 176. The clamping brackets will have a support web 178 on the backside. On each side of the angled frame member 174 are flanges 180 matching flanges 182 on the clamping brackets with matching orifices 184 for mounting hardware.

FIG. 29 depicts a front view of a slight modification of the preferred embodiment of the vehicle accessory hoist 10A where the angle A of the primary support arms 30 and angle A of the secondary support arms 32 are not equal. By altering the angular position of the secondary support arms 32 with relation to the primary support arms 30 varying load carrying capabilities can be achieved.

FIG. 30 depicts a front view of a slightly modified first alternate embodiment 10B using two additional support arms 186 and a short actuating mechanism 12. The pivot joints 23 and link arm 25 will remain essentially similar.

FIG. 31 depicts a perspective detail of an optional locking system in the upright position while holding the trailer hitch tongue 100 in the tubular hoist receiver 42. The locking action is accomplished by the means of a locking pin 188 inserted though the locking pin orifice 24 engaging against the two primary support arms 30 to be locked in place between two lock plates 190 with a conventional lock 69.

The vehicle accessory hoists 10A, 10B and 10C shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described may be employed for providing vehicle accessory hoists 10A, 10B and 10C in accordance with the spirit of this invention, and such changes, alterations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A vehicle accessory hoist comprising:
(a) a square tubular hoist frame member fixed to a hoist mounting tongue, for the purpose of attaching said hoist frame member to a vehicle, having two or more primary support arm mounting brackets and two or more secondary support arm mounting brackets integral to said hoist frame member;
(b) two or more primary support arms pivotally attached to said primary support arm mounting brackets and two or more secondary support arms pivotally attached to said secondary support arm mounting brackets;
(c) a hoist receiver unit including a tubular hoist receiver and having two or more primary support arm pivotal connections pivotally attached to said primary support arms and two or more secondary support arm pivotal connections pivotally attached to said secondary support arms; and
(d) an actuating mechanism in communication with an actuating mechanism power supply, pivotally attached to said hoist frame member and pivotally attached to said hoist receiver unit
whereby when said actuator mechanism is actuated, said hoist receiver unit is raised or lowered.

2. The vehicle accessory hoist according to claim 1, wherein said hoist frame member includes a conventional square tubular hoist mounting tongue adaptable to numerous conventional vehicle receiver hitch configurations.

3. The vehicle accessory hoist according to claim 1, further comprising a spring loaded locking mechanism.

4. The vehicle accessory hoist according to claim 1, wherein said hoist frame member is constructed in a square channel configuration instead of a square tubular configuration for the purpose of adapting said hoist frame member to be directly attached to a vehicle bumper or frame.

5. The vehicle accessory hoist according to claim 1, wherein said hoist receiver unit including a tubular hoist receiver further includes a tubular hoist receiver having retainer binding bolt to prevent movement.

6. The vehicle accessory hoist according to claim 1, wherein said hoist receiver unit includes a conventional tubular hoist receiver adaptable to attach directly to numerous commercially available hitch accessories.

7. The vehicle accessory hoist according to claim 1, wherein said actuating mechanism includes a conventional hydraulic cylinder or pneumatic cylinder actuator.

8. The vehicle accessory hoist according to claim 1, wherein said actuating mechanism includes a conventional winch actuator.

9. The vehicle accessory hoist according to claim 1, wherein said actuating mechanism is remotely controlled by a remote control unit for the purpose of safe raising and safe lowering operations.

10. The vehicle accessory hoist according to claim 1, further including a hoist receiver unit having a flat upper surface support member adapted to receive a wedge piece having a wedge piece orifice wherein said hoist receiver unit stops and rests upon said wedge piece laying flat upon said flat upper surface.

11. The vehicle accessory hoist according to claim 1, wherein said primary support arms have integral thereto a primary support arm cross bar whereby when the vehicle accessory hoist is raised the secondary support arms come to stop and rest upon said primary support arm cross bar, thereby increasing stability of the entire device.

12. A method for making a vehicle accessory hoist comprising the steps of:
(a) providing a square tubular hoist frame member fixed to a hoist mounting tongue, for the purpose of attaching said hoist frame member to a vehicle, having two or more primary support arm mounting brackets and two or more secondary support arm mounting brackets integral to said hoist frame member;
(b) providing two or more primary support arms pivotally attached to said primary support arm mounting brackets and two or more secondary support arms pivotally attached to said secondary support arm mounting brackets;
(c) providing a hoist receiver unit including a tubular hoist receiver and having two or more primary support arm pivotal connections pivotally attached to said primary support arms and two or more secondary support arm pivotal connections pivotally attached to said secondary support arms; and
(d) providing an actuating mechanism in communication with an actuating mechanism power supply, pivotally attached to said hoist frame member and pivotally attached to said hoist receiver unit
whereby when said actuator mechanism is actuated, said hoist receiver unit is raised or lowered.

13. The method for making a vehicle accessory hoist according to claim 12, wherein said step of providing a hoist frame member further comprises the step of providing a hoist frame member including a conventional square tubular hoist mounting tongue adaptable to numerous conventional vehicle receiver hitch configurations.

14. The method for making a vehicle accessory hoist according to claim 12, wherein said step of providing a hoist frame member further comprises the step of providing a hoist frame member constructed in a square channel configuration instead of a square tubular configuration for the purpose of adapting said hoist frame member to be directly attached to a vehicle bumper or frame.

15. The method for making a vehicle accessory hoist according to claim 12, wherein said step of providing a hoist receiver unit further comprises the step of providing a hoist receiver unit which includes a tubular hoist receiver having retainer binding bolt to prevent movement.

16. The method for making a vehicle accessory hoist according to claim 12, wherein said step of providing a hoist receiver unit further comprises the step of providing a conventional tubular hoist receiver adaptable to attach directly to numerous commercially available hitch accessories.

17. The method for making a vehicle accessory hoist according to claim 12, wherein said step of providing an actuating mechanism in communication with an actuating mechanism power supply further comprises the step of providing an actuating mechanism wherein said actuating mechanism includes a conventional hydraulic cylinder or pneumatic cylinder actuator.

18. The method for making a vehicle accessory hoist according to claim 12, wherein said step of providing an actuating mechanism in communication with an actuating mechanism power supply further comprises the step of providing an actuating mechanism wherein said actuating mechanism includes a conventional winch actuator.

19. The method for making a vehicle accessory hoist according to claim 12, wherein said step of providing a hoist receiver unit further includes the step of providing a hoist receiver unit having a flat upper surface support member adapted to receive a wedge piece having a wedge piece orifice wherein said hoist receiver unit stops and rests upon said wedge piece laying flat upon said flat upper surface.

20. The method for making a vehicle accessory hoist according to claim 12, wherein said step of providing a hoist receiver unit further includes the step of providing a hoist receiver unit wherein said primary support arms have integral thereto a primary support arm cross bar whereby when the vehicle accessory hoist is raised the secondary support arms come to stop and rest upon said primary support arm cross bar, thereby increasing stability of the entire device.
